(19) United States
(12) Patent Application Publication
(10) Pub. No.: US 2005/0238772 A1
(43) Pub. Date: Oct. 27, 2005

(54) Bakery tray and process for baking food batter

(76) Inventor: Robert Edward Stease, Loveland, OH (US)

Correspondence Address: HASSE & NESBITT LLC, 7550 CENTRAL PARK BLVD., MASON, OH, 45040, US

(21) Appl. No.: 10/831,394

(22) Filed: Apr. 23, 2004

(51) Int. Cl. A23B 4/00

(52) U.S. Cl. 426/505

(57) ABSTRACT

A bakery tray having a central region comprising at least one orifice having attached fingers that provide support for holding an article placed in the orifice. In one embodiment, the tray is made of a paper, such as paperboard or corrugated material. The tray may be made from a blank in which the fingers are die-cut and pressed below the plane of the blank. The tray can be used to support a flexible container such as a paper cup that holds a fluid batter of a food product during baking. The tray may also be used to store and transport the baked product. The invention also relates to a process for baking a food batter using the tray.

### FIELD OF THE INVENTION

This invention relates to a bakery tray for supporting an article placed in an orifice of the tray, particularly a tray that can support a flexible container holding a fluid batter of a food product during baking. The tray may also be used to store and transport the baked product. The invention also relates to a process for baking a food batter using the tray.

### BACKGROUND OF THE INVENTION

Current processes for baking food products such as muffins and cupcakes typically use a hard metal pan shaped to hold paper baking cups into which the batter is poured. After baking, the products are taken out of the pan with the baking cups attached. In the case of bakery processors, the baked products are typically transferred to other forms of packaging for shipment to consumers or retail outlets.

The metal pan used in the baking process provides structural rigidity that allows for the handling of many baked products at one time. In the case of typical industrial ovens, the pan is used to transport the batter through the oven, as well as controlling the shape of the baked product. The metal pan also assists the baking process via conduction heat.

Because of the cost associated with using such metal pans (e.g., the original cost, and costs for washing, re-glazing and eventually replacing the pans) and the labor and/or waste involved in taking the baked products out of the pans, alternative ways of transporting the batter through the baking process have been proposed. These alternatives have either been cost prohibitive or do not adequately perform all of the functions provided by the metal pans.

Thus there is a continuing need for an improved, low-cost, lightweight tray useful for supporting a batter of a food product during the baking process.

### SUMMARY OF THE INVENTION

The invention relates to a bakery tray having an XY plane and a Z-direction perpendicular thereto, said tray comprising a periphery and a central region. The central region of the tray comprises at least one orifice having a plurality of fingers extending below the XY plane. The fingers are attached to the circumference of the orifice, are moveable in the Z-direction below the XY plane, and provide support for an article placed in the orifice.

The invention also relates to a process for baking a food batter, said process comprising:
(a) providing a bakery tray as described above;
(b) providing a flexible container holding the food batter in the orifice of the tray;
(c) baking the batter in an oven for a period of time to form the baked food product; and
(d) removing the tray and baked food product from the oven.

In one embodiment, the tray of the invention is made of paper, such as corrugated paper or paperboard material. In another embodiment, the fingers are die-cut in one or more shapes from the central region of the tray, such as a corrugated blank. Each finger is die-cut such that its proximal end is attached to the circumference of the orifice, and its distal end is movable in the Z-direction below the XY plane when pressed away from the XY plane of the tray. When pressed, the finger becomes discontinuous along at least some portion of the die-cut lines. The pressing process alters the shape and memory of the pressed region of the XY plane. The pressing process typically flattens the substrate, e.g., a corrugated blank, such that the unpressed portion outside of the orifice is thicker than all or parts of the pressed portion of the substrate. The result is a tray having a multi-planar form, with fingers extending below the XY plane. Other portions of the substrate that are not pressed may be designed to accommodate a particular application.

In one aspect, the bakery tray is a carrier for a flexible container such as a baking cup that holds a fluid food batter during the baking process. In another embodiment, the tray may be an insert for, or a portion of, a finished tray or box that can be used to transport the food product during or after the baking process. Such an insert need not be self-supporting, and may be put into a tray or box for support. The baked product need not be removed from the tray or insert before shipping, and the tray or insert containing the baked product may be placed directly into a shipping or display box for the product. The tray thus provides cost savings compared to the metal pan alternative described above. The tray can be used for carrying any food product that is processed by pouring batter into a flexible container, such as a paper baking cup, that needs to be supported during the baking process. Examples of such products include muffins, bakery loaves, and cupcakes.

### BRIEF DESCRIPTION OF THE DRAWINGS

FIG. 1 is a perspective view of one embodiment of a bakery tray of the invention.

FIG. 2 is a top plan view of the tray of FIG. 1.

FIG. 3 is a frontal view of the tray of FIG. 1.

FIG. 4 is a sectional view of the tray of FIG. 2, taken along line 4-4.

FIG. 5 is a bottom plan view of the tray of FIG. 1.

FIG. 6 is a perspective view of a bakery tray of the invention stacked on top of another tray, with each tray supporting a muffin.

FIG. 7 is a frontal view of the trays of FIG. 6.

FIG. 8 is a perspective view of another bakery tray of the invention.

FIG. 9 is a top plan view of the tray of FIG. 8.

FIG. 10 is a frontal view of the tray of FIG. 8.

FIG. 11 is a sectional view of the tray of FIG. 9, taken along line 11-11.

FIG. 12 is a perspective view of a bakery tray of the invention stacked on top of another tray, with each tray supporting a muffin.

FIG. 13 is a frontal view of the trays of FIG. 12.

### DETAILED DESCRIPTION OF THE INVENTION

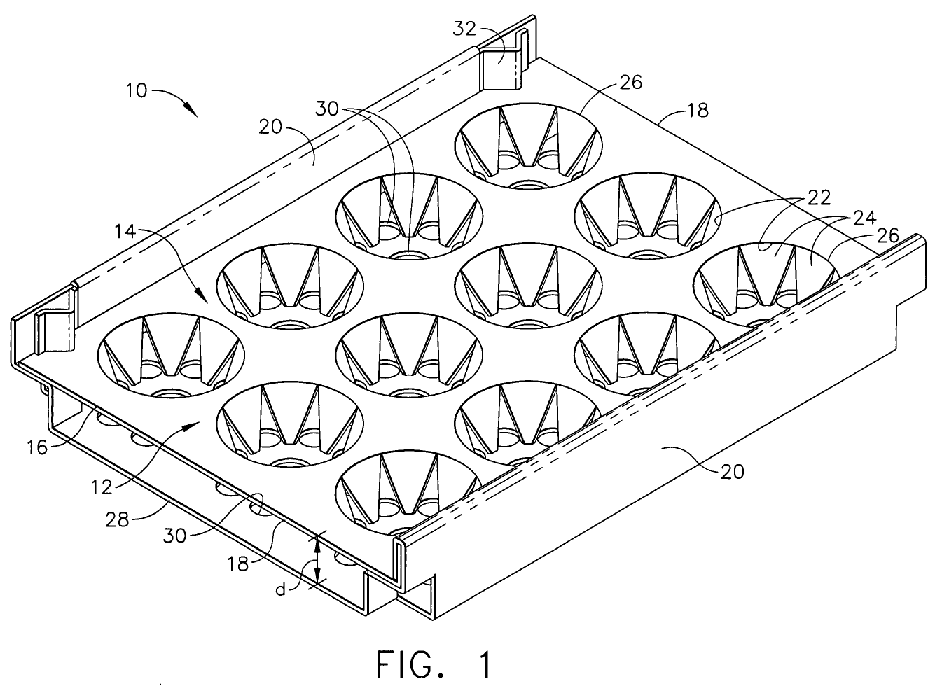

Referring to FIG. 1, a bakery tray 10 according to one embodiment of the invention has an XY plane 12 and a Z-direction perpendicular to the XY plane. The tray 10 comprises a central region 14 and a periphery 16. The central region 14 and periphery 16 are typically disposed in the XY plane 12, such as shown in FIG. 1.

Bakery trays of the invention may have other configurations besides that shown in FIG. 1. For example, it is not necessary that both the central region and the periphery be disposed in or parallel to the XY plane, or be generally planar. The central region and the periphery may be spaced apart in the Z-direction. Trays having a slightly concave or convex shape can be used in the invention. Moreover, the trays need not be axisymmetric trays or trays that are symmetric about any particular plane.

The boundary and shape of the periphery 16 are defined by the edges 18 and by the sidewalls 20 of the tray 10. Of course, other trays of the invention, and particularly trays that are inserts for finished trays or boxes, need not have sidewalls for support. The dimensions and relative proportions of the periphery 16 and central region 14 of the tray 10 will vary according to the exact size and intended use of the tray. While a rectangular tray is illustrated in FIG. 1, any suitable shape and depth of the tray may be selected for use with the invention. Other suitable shapes include squares, circles, ovals, various polygons, etc.

The central region 14 of the tray 10 comprises at least one orifice, such as orifice 22. The central region often comprises at least two, and in some embodiments at least four, orifices. For example, trays intended for use in baking muffins or cupcakes often have six, eight, nine or twelve orifices. Each orifice may be in the shape of a circle, such as shown in FIG. 1, an oval, a rectangle, a square, or various other polygons. Typically, the orifices all have the same shape. Each orifice 20 may be formed by die-cutting a plurality of fingers, such as fingers 24, in the central region 14 of tray 10 and then pressing the fingers so that they extend below the XY plane 12. The fingers may also be formed by otherwise making cuts, perforations, or score and fold lines in the central region of the tray and pressing the fingers below the XY plane. Alternatively, the tray, or at least the central region thereof, may be molded or thermoformed with at least one orifice having a plurality of fingers extending below the XY plane.

The fingers are attached to the circumference of the orifice, such as circumference 26 of orifice 22, and are moveable in the Z-direction below the XY plane. The fingers provide support for an article placed in the orifice. For example, the pleated wall of a typical baking cup, if unsupported, will tend to bulge outward in a region slightly above the bottom of the cup when it is filled with fluid batter as a result of the hydrostatic pressure exerted by the batter. A feature of the tray of the invention is that the fingers provide support to the walls of the paper cup. In one embodiment, the fingers are die-cut from the central region of the XY plane of the tray and pressed in the Z-direction below the XY plane. Each orifice typically has at least three fingers, and often at least four fingers, extending below the XY plane. The length, width, shape and support provided by the fingers may be selected for the desired application.

As illustrated in FIG. 1, the tray 10 is typically multi-planar, i.e., different portions of the tray lie in different planes. The central region 14 and periphery 16 of tray 10 are disposed in the XY plane 12, and the fingers 24 attached to the orifices 22 extend below the XY plane. In addition, the tray 10 comprises a second plane 28 that is substantially parallel to the XY plane and spaced apart from it in the Z-direction. The distance d between these two planes can vary depending on the design and end-use of the tray. However, for a tray intended for baking muffins, this distance is typically from about 1 to about 2 inches (about 2.5 to about 5.1 cm). In FIG. 1, the fingers 24 extend between the XY plane 12 and the second plane 28. The distal ends of the fingers 24 may touch the upper surface of the second plane 28, such as shown in FIG. 1, but need not extend this far in the Z-direction or touch the second plane.

The second plane 28 shown in FIG. 1 comprises a plurality of holes 30, which are typically located beneath each orifice 22 so that heat from the oven is more uniformly distributed around the paper baking cups holding the food batter that are placed in the orifices. It is believed that this results in more efficient and uniform baking of the food product. The size and number of holes 30 in the second plane 28 can be selected to provide the desired support and the desired baking conditions for the particular product.

The tray 10 may be made of any rigid or semi-rigid material, particularly a material capable of supporting a plurality of baking cups holding food batter, and transporting and storing such food products during and after the baking process. The tray 10 may be made of cellulose, such as solid bleached sulfite paperboard and various types of wood fibers, including recycled fibers. Alternatively, the tray 10 may be made from or include foam, plastic and other synthetic materials.

In one embodiment, the tray 10 is made of corrugated paper that comprises three plies: a first ply, a second ply and a third ply. The second ply spaces the first and third plies apart in the Z-direction. It is not necessary that the first, second and third plies be made of identical material. The first ply is typically sanitary, and may be aesthetically pleasing to the consumer. The second and third plies are not so limited, and may be chosen for strength, aesthetic properties, and cost.

A corrugated construction typically comprises first or third outer plies and a corrugated ply therebetween. The corrugated ply is not joined at all positions to the outer plies, but instead has corrugations comprising troughs and ribs that are spaced apart from the flat plies. The ribs and troughs are often straight and parallel. In cross section, the ribs may have any configuration known in the art. Suitable corrugated materials include any size flutes, e.g., B, C, E, or F size flutes. A wave flute corrugated medium having corrugations with vector components parallel to both the X and Y directions may be also suitable. This arrangement provides properties that are more nearly equivalent in the X and Y directions. A particularly common wave flute corrugated medium has corrugations that approximate a sinusoidal pattern.

If desired, one or more of the plies may be treated with re-enforcing material known in the art. If only one ply is treated for strength, typically it is the second ply. The second ply may have increased strength because it transmits compressive and bending loads applied to the tray. For example, the second ply may be treated with epoxy or other synthetic resins known in the art. Additionally or alternatively, the second ply may be treated with lignin. Various other means may be used to strengthen one or more of the plies. For example, radial-reinforcing ribs may be applied to the underside of the tray and joined to the third ply. Such reinforcing ribs will distribute loads applied near the center of the tray towards its edges. The corrugated paper, comprising all three plies, may have a combined basis weight of 100 to 1,000 grams per square meter, for example, a basis weight of 125 to 700 grams per square meter.

If desired, the three plies may be provided separately, rather than as a unitary laminate. The three plies may be joined together in the same process that deforms the blank into the multi-ply tray. Such a process may be accomplished as follows. The second ply may have adhesive applied to those portions that contact the first and third plies. For example, if a corrugated material is selected for the second ply, the crests of the ribs of the corrugations may be adhesively coated, for example by printing, as known in the art. Each corrugation need not have adhesive applied thereto, e.g., alternate corrugations or peripheral corrugations could be adhesively coated, depending on the lamination strength desired. Alternatively, the inner surfaces of the first and third plies may be adhesively coated. Suitable adhesives include pressure sensitive and starch based adhesives.

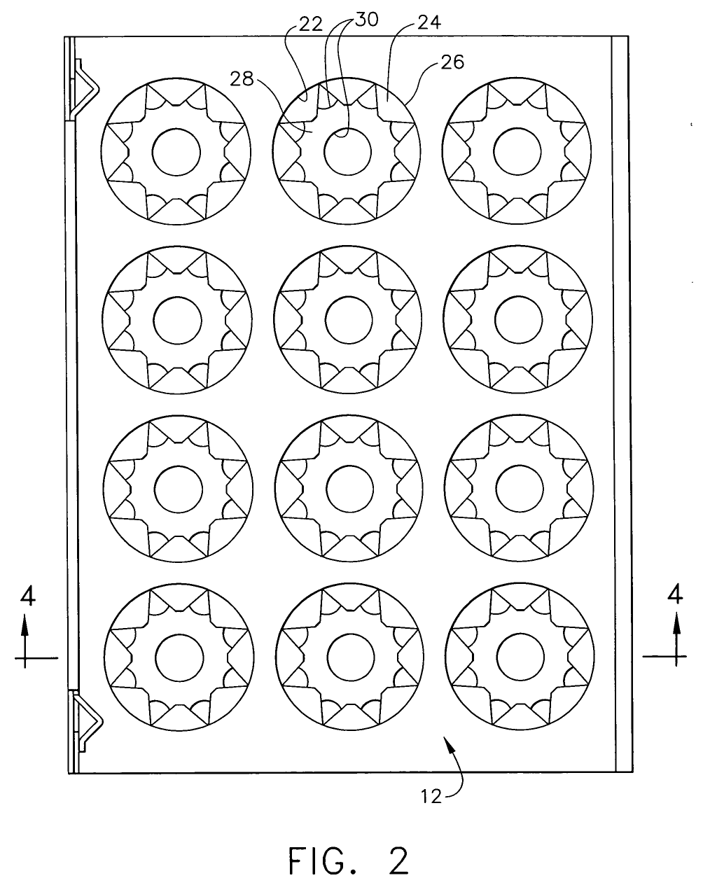

FIG. 2 is a top view of the tray of FIG. 1. In this embodiment, each orifice 22 has eight fingers 24 attached its circumference 26 and extending below the XY plane 12. The second plane 28 comprises a large hole 30 centrally located below each orifice 22, and eight smaller holes 30 surrounding the large hole that is located substantially below the orifice. The size, number, and shape of the holes in the XY plane can be selected, along with the distance d between the XY plane and the second plane (shown in FIG. 1), to provide the desired support and the desired air circulation and convection heating during baking of the food batter.

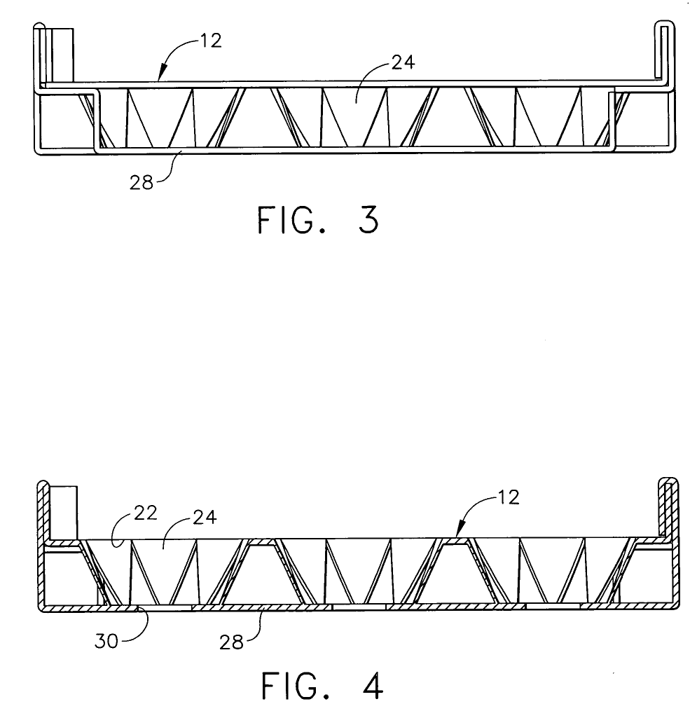

FIG. 3 is a frontal view of the tray of FIG. 1 showing the fingers 24 extending from the XY plane 12 to the second plane 28. This also illustrates the open framework of the tray that allows for sufficient air circulation and convection heating for the baking process. This open framework is also shown in FIG. 4, which is a sectional view of the tray of FIG. 2 taken along line 4-4. In addition to the fingers 24 extending from the XY plane 12 to the second plane 28, FIG. 4 shows the large holes 30 in the second plane 28 that are centrally located below the orifices 22 in the XY plane 12.

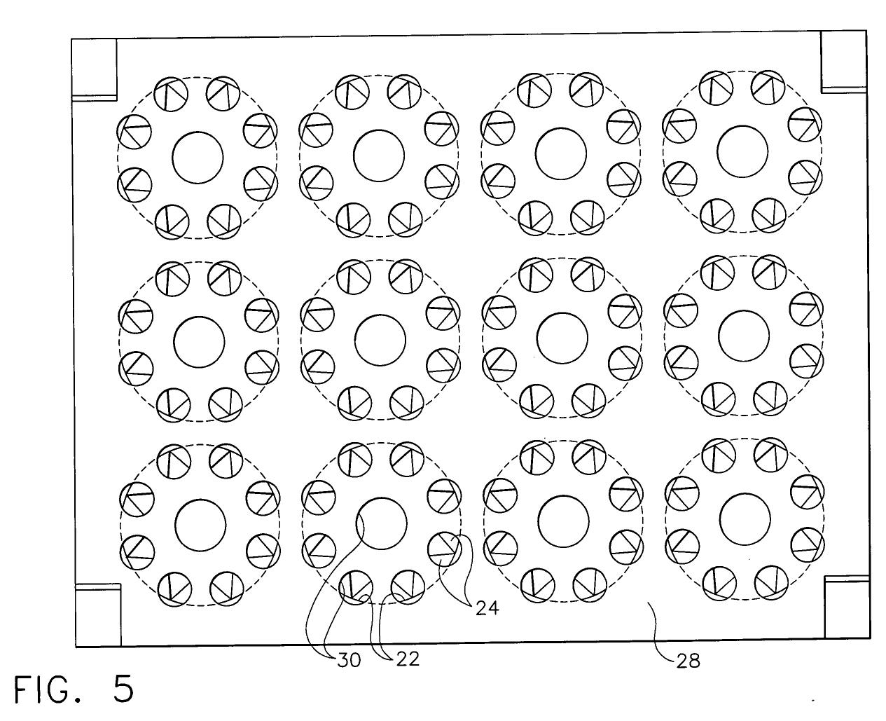

FIG. 5 is a bottom view of the tray of FIG. 1. This view shows the large holes 30 in the second plane 28 that are centrally located under the orifices 22, and eight smaller holes 30 in the second plane 28 that surround the large holes and are located substantially under the orifices 22. Also visible through the smaller holes 30 are portions of the fingers 24.

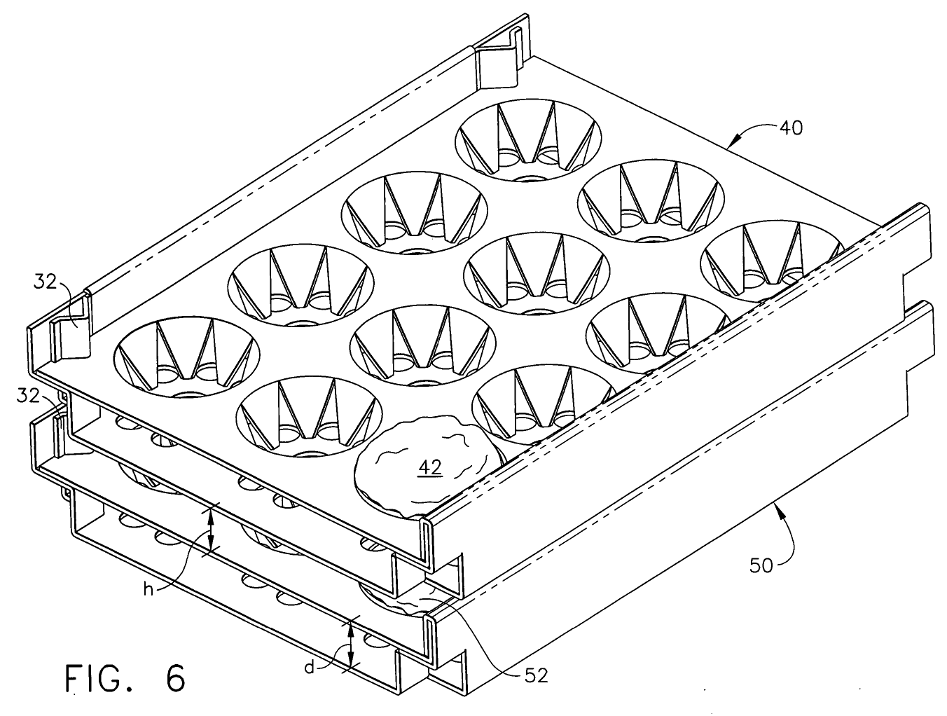

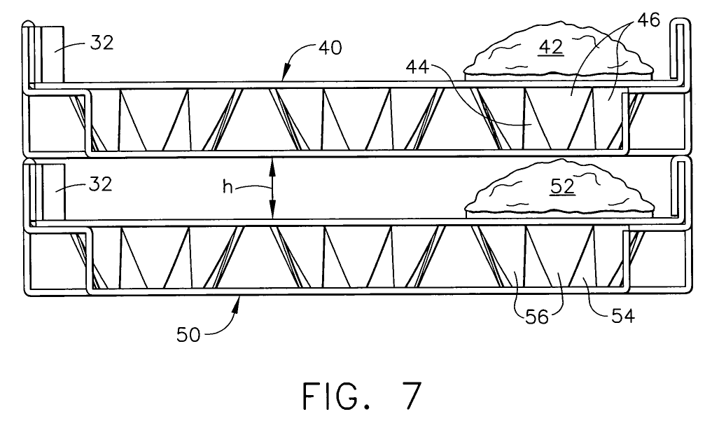

FIG. 6 illustrates a bakery tray 40 of the invention stacked on top of another tray 50. The top tray 40 contains a muffin 42, and bottom tray 50 contains a muffin 52. Support structures 32 help prevent the top tray from contacting muffins in the bottom try if the top tray slips from alignment over the bottom tray. (This supporting structure is more clearly shown in FIG. 7.) FIG. 6 also shows the distance h between the top tray 40 and the bottom tray 50, and the distance d between the XY plane and the second plane of the bottom tray. For trays intended for use in baking muffins, the distance h is typically from about 1 to about 1.75 inches (about 2.5 to about 4.5 cm), and the distance d is typically from about 1 to about 2 inches (about 2.5 to about 5.1 cm).

FIG. 7 is a frontal view of the trays of FIG. 6 showing the fingers 46 of top tray 40 supporting a paper baking cup 44 holding muffin 42. Similarly, fingers 56 of bottom tray 50 support the paper baking cup 54 holding muffin 52. The distance h between the top tray 40 and bottom tray 50 should be selected so that muffins in the bottom tray do not touch the bottom surface of the top tray.

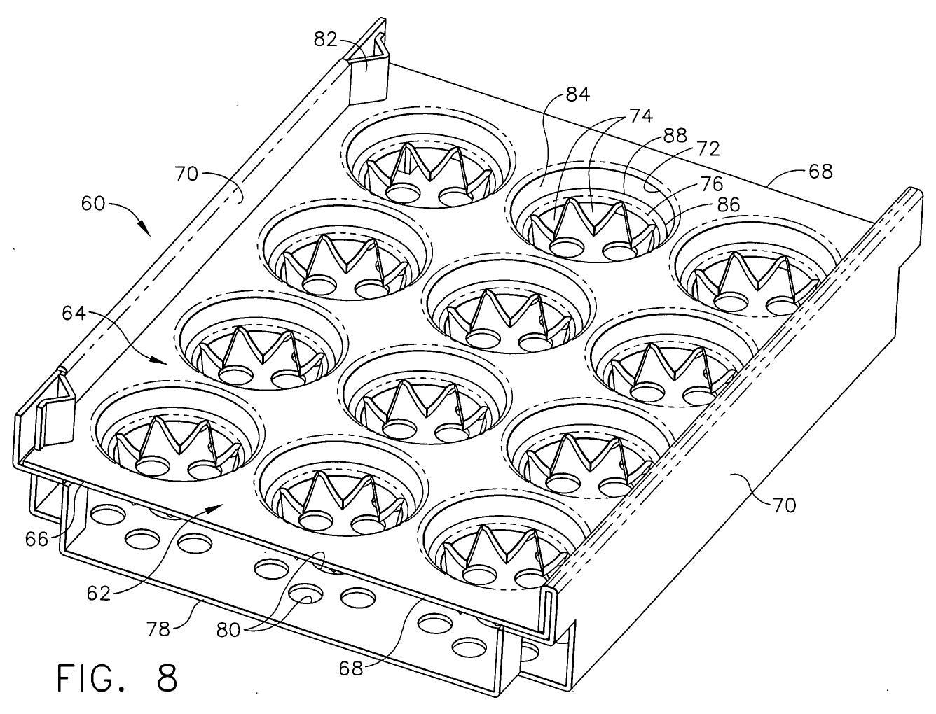

FIG. 8 illustrates another bakery tray 60 of the invention. Tray 60 has an XY plane 62 and a Z-direction perpendicular to the XY plane. The tray 60 comprises a central region 64 and a periphery 66, which are typically disposed in the XY plane 62 as shown in FIG. 8. The boundary and shape of the periphery 66 are defined by the edges 68 and by the sidewalls 70 of the tray 60. The dimensions and relative proportions of the tray will vary according to the exact size and intended use of the tray. While a rectangular tray is illustrated in FIG. 8, any suitable shape and depth of tray may be selected for use with the invention. Other suitable shapes include squares, circles, ovals, various polygons, etc.

The central region 64 of the tray 60 comprises at least one orifice, such as orifice 72. The central region often comprises at least two, and in some embodiments at least four, orifices, e.g., the tray in FIG. 8 has twelve orifices. Each orifice may be in the shape of a circle, such as shown in FIG. 8, an oval, a rectangle, a square, or various other polygons. Typically, the orifices all have the same shape. Each orifice 72 comprises a bowl-shaped lip 84 extending in the Z-direction from the XY plane 62. The base 86 of the bowl lies in a plane substantially parallel to the XY plane 62. The lip 84 forms a continuous transition region between the XY plane 62 and the base 86, which are spaced apart in the Z-direction. By “continuous transition region” it is meant that the deviations or changes in the Z-direction position occur without fold lines, cuts, scores or perforations. The lip 84 may be formed by deforming this portion of the XY plane 62 out of its plane by mating platens, as is known in the art. The platens both clamp the multi-ply blank and deform it in the Z-direction. An inner orifice 88 is formed by die-cutting a plurality of fingers, such as fingers 74, in the base 86 of the bowl and then pressing the fingers so that they extend in the Z-direction further below the XY plane. The fingers may also be formed by otherwise making cuts, perforations, or score and fold lines in the base 86 of the bowl and pressing the fingers in the Z-direction further below the XY plane. Alternatively, the tray, or at least the central region thereof, may be molded or thermoformed with at least one orifice having a plurality of fingers extending below the XY plane.

The fingers 74 are attached to the circumference of the orifice, such as circumference 76 of orifice 72, and are moveable in the Z-direction below the XY plane. The fingers provide support for an article placed in the orifice. In one embodiment, the fingers are die-cut from the central region of the XY plane of the tray and pressed in the Z-direction below the XY plane. Each orifice typically has at least three fingers, and often at least four fingers, extending below the XY plane. Of course, the length, width, shape and support provided by the fingers may be selected for the desired application.

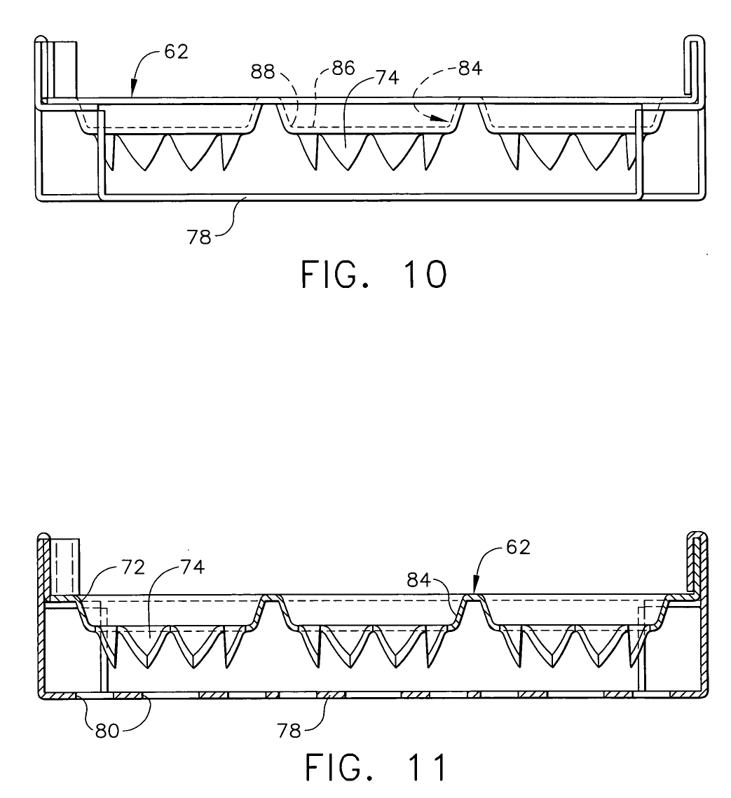

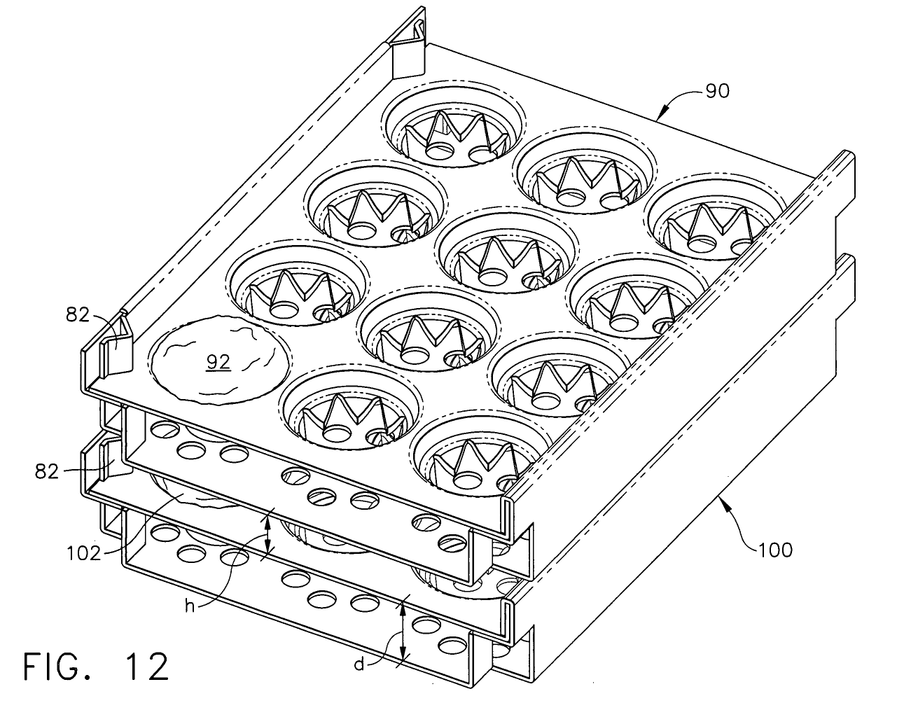

As illustrated in FIG. 8, the tray 60 is typically multi-planar, i.e., different portions of the tray lie in different planes. The central region 64 and periphery 66 of the tray 60 are disposed in the XY plane 62, and the fingers 74 attached to the orifices 72 extend below the XY plane and spaced apart from it in the Z-direction. In addition, the tray 60 comprises a second plane 78 that is substantially parallel to the XY plane. The distance d between these two planes can vary depending on the design and end-use of the tray. However, for a tray intended for baking muffins, this distance is typically from about 1 to about 2 inches (about 2.5 to about 5.1 cm). In FIG. 8, the fingers 74 extend between the XY plane 62 and the second plane 78. The distal ends of the fingers 74 may touch the upper surface of the second plane 78, or as more clearly shown in FIGS. 10-11, they may extend only about half way toward the second plane in the Z-direction.

The second plane 78 shown in FIG. 8 comprises a plurality of holes 80, which are typically located beneath each orifice 72 so that heat from the oven is more uniformly distributed around the paper baking cups holding the batter that are placed in the orifices. It is believed that this results in more efficient and uniform baking of the food product. The size and number of holes 80 in the second plane 78 can be selected to provide the desired support and the desired baking conditions for the particular product.

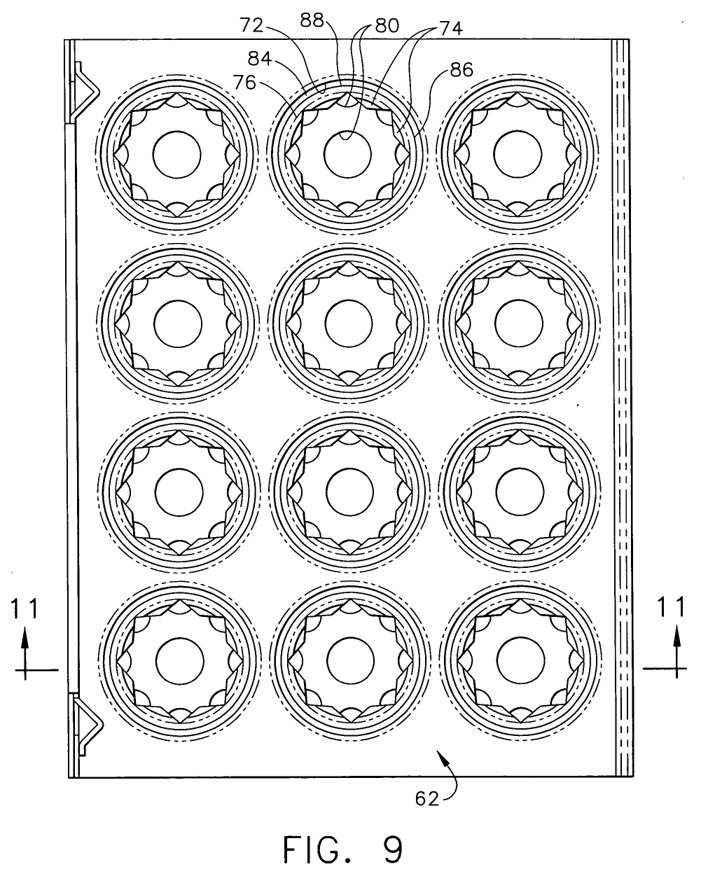

FIG. 9 is a top view of the tray of FIG. 8. In this embodiment, each orifice 72 has eight fingers 74 attached to its circumference 76 and extending below the XY plane 62. Each orifice 72 also has a lip 84, a base 86, and an inner orifice 88. The second plane 78 comprises a large hole 80 centrally located below each orifice 72, and eight smaller holes 80 surrounding the large hole and located substantially below the orifice. The size, number and shape of the holes in the XY plane can be selected, along with the distance d between the XY plane and the second plane (shown in FIG. 8), to provide the desired support and the desired air circulation and convection heating during baking of the food batter.

FIG. 10 is a frontal view of the tray of FIG. 8 showing the fingers 74 extending from the XY plane 62 toward the second plane 78. This also illustrates the open framework of the tray that allows for sufficient air circulation and convection heating for the baking process. This open framework is also shown in FIG. 11, which is a sectional view of the tray of FIG. 9 taken along line 11-11. In addition to the fingers 74 extending from the XY plane 62 to the second plane 78, FIG. 11 shows the large holes 80 in the second plane 78 that are centrally located below the orifices 72 in the XY plane 62.

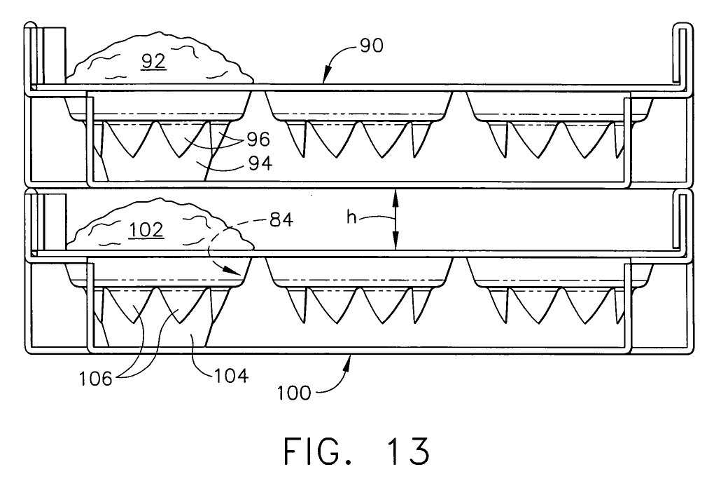

FIG. 12 illustrates a bakery tray 90 of the invention stacked on top of another tray 100. The top tray 90 contains a muffin 92, and bottom tray 100 contains a muffin 102. Support structures 82 help prevent the top tray from contacting muffins in the bottom tray if the top tray slips from alignment over the bottom tray. (This is more clearly shown in FIG. 13.) FIG. 12 also shows the distance h between the top tray 90 and the bottom tray 100, and the distance d between the XY plane and the second plane of the bottom tray. For trays intended for use in baking muffins, the distance h is typically from about 1 to about 1.75 inches (about 2.5 to about 4.5 cm), and the distance d is typically from about 1 to about 2 inches (about 2.5 to about 5.1 cm).

FIG. 13 is a frontal view of the trays of FIG. 12 showing the fingers 96 of top tray 90 supporting a paper baking cup 94 holding muffin 92. Similarly, fingers 106 of bottom tray 100 support the paper baking cup 104 holding muffin 102. The distance h between the top tray 90 and bottom tray 100 should be selected so that muffins in the bottom tray do not touch the bottom surface of the top tray.

The bakery trays of the invention can be made in various ways, depending on the particular application. In one embodiment, two rectangular corrugated paper or paperboard blanks are die cut, perforated and/or scored by various means known in the industry to form the desired holes and score lines. One blank is converted in a manner such that it forms the lower plane of the tray. The other blank is converted in a manner such that it forms the upper plane of the tray. After die cutting and scoring the blanks and prior to set-up or shipping to the bakery processor, the upper plane is thermoformed at the orifice areas, forming the fingers as described above. The lower blanks are shipped to the bakery processor flat and the upper blanks are shipped nested with each other. At the processor's facility, the two blanks are folded along the perforation and/or score lines and constructed either manually or automatically and joined either by glue or mechanically to form the bakery tray. The blanks may be printed and/or coated. Alternatively, the tray may be formed from a single blank that is converted in a manner to form both the upper and lower planes.

In another embodiment, the upper plane is converted in a manner to form an insert that can be placed (manually or automatically) into a pre-formed tray (formed manually or automatically, and constructed either by glue or mechanically) that is the lower plane of the system. The tray typically has vent holes die-cut in the bottom and sides of the tray, but in some applications vent holes may not be required. The insert may or may not be attached to the tray. As in the first case, the bottom tray may be shipped flat to the processor and erected at the processor's facility. The upper insert may be shipped nested and placed in the tray. Further erection of the insert may or may not be necessary depending on the design requirements.

In one aspect, the invention also relates to a process for baking a food batter, said process comprising:
(a) providing a bakery tray having an XY plane and a Z-direction perpendicular thereto, said tray comprising a periphery and a central region, said central region comprising at least one orifice having a plurality of fingers extending below the XY plane, said fingers being attached to the circumference of the orifice and being moveable in the Z-direction below the XY plane, said fingers providing support for a flexible container holding the food batter placed in the orifice;
(b) providing a flexible container holding the food batter in the orifice of the tray;
(c) baking the batter in an oven for a period of time to form a baked food products; and
(d) removing the tray and baked product from the oven.

During a commercial baking process, the formed or assembled tray is typically transported by a conveyor to a station where flexible containers such as pleated paper baking cups are inserted into the orifices of the tray so that the cups are supported by the fingers of the tray. The paper baking cups may be the same as those used in the conventional baking process with metal pans, e.g., some are made of about 30 lb. (about 13.6 kg) test solid bleached sulphate grease-proof paper.

After the paper cups are positioned in the orifices, the tray typically advances to a station underneath a reservoir filled with batter and having a plurality of delivery spouts equal in number and spacing to the cups in the tray. A predetermined amount of batter is delivered simultaneously from each spout to the corresponding baking cup beneath it. The tray of batter-filled cups then proceeds to an oven where the batter is baked for a predetermined time and temperature. For muffins or cupcakes, the baking time may be from about 12 to 15 minutes at 325° F. to 350° F. (about 163° C. to 177° C.).

Following the baking step, the tray with the fully baked products is transported from the oven to a cooling station for a predetermined time. The tray may then move to another station underneath another reservoir containing sugar, icing or other topping, and also equipped with a plurality of spouts equal in number and spacing to the products on the tray. A predetermined amount of topping can be deposited on the top of each food product when the tray is positioned under the reservoir. The tray of completed food products then typically moves to a loading station where the products may be inspected. The full tray is typically inserted into a delivery and display carton, which after closure and sealing is ready for shipping or purchase by a consumer. The tray should be sized to fit snugly within the box, thereby protecting the contents from shifting and consequent damage.

The invention thus provides an inexpensive, e.g. corrugated or paperboard, tray that can be made in a wide variety of shapes and sizes for both baking and packaging bakery items. The invention eliminates the need for removing individual baked products from conventional metal baking pans and for handling the products individually through the inspecting and packaging steps. Also eliminated is the entire cycle of operations performed on the pans themselves, (i.e., stacking, washing, inspecting, glazing, and replacing pans).

Furthermore, the method of the invention may be adapted to an automated or semi-automated production process. In such an operation, cases of thermoformed-nested trays can be delivered to the feed hopper of a setup machine that erects the trays and places them on a conveyor. Alternatively, a tray of the invention may be inserted into a pre-erected tray. Another machine may then insert the paper baking cups into the orifices of each tray. The trays move at a predetermined rate to an automatic batter pouring station, and the filled trays then enter an oven sized to provide sufficient baking time in relation to the conveyor rate. Any desired icing or topping step may be automated in the same manner as the batter pouring step. The trays are typically then inserted into cartons that have been set up from a flat blank by an automatic forming machine. A final machine may then close and seal the box. Alternatively, the trays may be film-wrapped and inserted into a display or shipping box.

Although various embodiments of the invention have been described and exemplified, it will be understood that the scope of the invention is not limited to that description. Changes and modifications will occur to those of ordinary skill in the art and they can be made without departing from the spirit and scope of the invention. The invention is considered to include the methods of accomplishing the results described herein as well as structures designed to accomplish them.

1. A bakery tray having an XY plane and a Z-direction perpendicular thereto, said tray comprising a periphery and a central region, said central region comprising at least one orifice having a plurality of fingers extending below the XY plane, said fingers being attached to the circumference of the orifice and being moveable in the Z-direction below the XY plane, said fingers providing support for an article placed in the orifice.

2. A tray according to claim 1 wherein the fingers are die-cut from the XY plane of the tray and pressed in the Z-direction below the XY plane.

3. A tray according to claim 1 wherein each orifice has at least four fingers extending below the XY plane.

4. A tray according to claim 1 wherein the central region of the tray comprises at least four orifices, each orifice having a plurality of fingers extending below the XY plane, said fingers being attached to the circumference of the orifice and being moveable in the Z-direction below the XY plane, said fingers providing support for an article placed in the orifice.

5. A tray according to claim 4 wherein each orifice has at least four fingers extending below the XY plane.

6. A tray according to claim 5 wherein the fingers are die-cut from the XY plane of the tray and pressed in the Z-direction below the XY plane.

7. A tray according to claim 6 made from corrugated paper material and paperboard material.

8. A tray according to claim 1 further comprising a second plane substantially parallel to the XY plane, wherein the plurality of fingers extend between the XY plane and the second plane.

9. A tray according to claim 8 wherein the second plane has a plurality of openings therein.

10. A tray according to claim 9 wherein the openings engage the fingers extending between the XY plane and the second plane.

11. A tray according to claim 9 wherein the central region of the tray comprises at least four orifices, each orifice having at least four fingers extending below the XY plane, said fingers being attached to the circumference of the orifice and being moveable in the Z-direction below the XY plane, said fingers providing support for an article placed in the orifice.

12. A tray according to claim 11 wherein the fingers are die-cut from the XY plane of the tray and pressed in the Z-direction below the XY plane.

13. A tray according to claim 12 made from corrugated paper material or paperboard material.

14. A tray according to claim 1 in the form of an insert for another tray or a box.

15. A tray according to claim 12 in the form of an insert for another tray or a box.

16. A bakery tray made of paper material having an XY plane and a Z-direction perpendicular thereto, said tray comprising a periphery and a central region, said central region comprising at least four orifices, each orifice having at least four fingers extending below the XY plane, said fingers being attached to the circumference of the orifice and being moveable in the Z-direction below the XY plane, said fingers providing support for an article placed in the orifice.

17. A tray according to claim 16 wherein the fingers are die-cut from the XY plane of the tray and pressed in the Z-direction below the XY plane.

18. A tray according to claim 17 further comprising a second plane substantially parallel to the XY plane, wherein the plurality of fingers extend between the XY plane and the second plane, and the second plane has a plurality of openings therein.

19. A process for baking a food batter, said process comprising:
(a) providing a bakery tray having an XY plane and a Z-direction perpendicular thereto, said tray comprising a periphery and a central region, said central region comprising at least one orifice having a plurality of fingers extending below the XY plane, said fingers being attached to the circumference of the orifice and being moveable in the Z-direction below the XY plane, said fingers providing support for a flexible container holding the food batter placed in the orifice;
(b) providing a flexible container holding the food batter in the orifice of the tray;
(c) baking the batter in an oven for a period of time to form a baked food product; and
(d) removing the tray and baked product from the oven.

20. A process according to claim 19 wherein the fingers are die-cut from the XY plane of the tray and pressed in the Z-direction below the XY plane.

21. A process according to claim 19 wherein each orifice has at least four fingers extending below the XY plane.

22. A process according to claim 19 wherein the central region of the tray comprises at least four orifices, each orifice having a plurality of fingers extending below the XY plane, said fingers being attached to the circumference of the orifice and being moveable in the Z-direction below the XY plane, said fingers providing support for an article placed in the orifice.

23. A process according to claim 19 wherein the tray is made of corrugated paper material or paperboard material.

24. A process according to claim 19 wherein the tray further comprises a second plane substantially parallel to the XY plane, wherein the plurality of fingers extend between the XY plane and the second plane.

25. A process according to claim 24 wherein the second plane has a plurality of openings therein.

26. A process according to claim 25 wherein the openings engage the fingers extending between the XY plane and the second plane.

27. A process according to claim 19 in the form of an insert for another tray or box.

28. A process according to claim 25 in form of an insert for another tray or box.

29. A process according to claim 25 wherein the central region of the tray comprises at least four orifices, each orifice having at least four fingers extending below the XY plane, said fingers being attached to the circumference of the orifice and being moveable in the Z-direction below the XY plane, said fingers providing support for an article placed in the orifice.

30. A process according to claim 29 wherein the fingers are die-cut from the XY plane of the tray and pressed in the Z-direction below the XY plane.

31. A process according to claim 30 wherein the tray is made from corrugated paper material.

32. A process according to claim 19 wherein the flexible container is a paper baking cup.

33. A process according to claim 31 wherein the flexible container is a paper baking cup.
